(19) United States
(12) Patent Application Publication
(10) Pub. No.: US 2011/0232173 A1
(43) Pub. Date: Sep. 29, 2011

(54) MULTIPURPOSE PELLETS AND METHOD OF MAKING SAME

(76) Inventor: Robert LEFEBVRE, Ste-Justine de Newton (CA)

(21) Appl. No.: 13/037,432

(22) Filed: Mar. 1, 2011

(30) Foreign Application Priority Data
Mar. 29, 2010 (CA) 2698024

(51) Int. Cl. A01G 13/02; A01K 1/015; B01J 20/22; B01J 20/26

(52) U.S. Cl. 47/9; 119/171; 502/404; 502/402

(57) ABSTRACT

A multipurpose pellet is provided comprising: from about 0.1% to about 100% by weight of a vegetable fiber chosen from cotton, bamboo fiber, rice fiber, esparto, papaya, coir, sisal, kapok, jute, ramie, flax, roselle hemp, hemp, kenaf, abaca, soybean fiber, okra fiber, vine fiber, banana fiber, rattan and nettlesjute; and from about 99.9% to about 0% by weight of cellulosic material.

### BACKGROUND

(a) Field

The subject matter disclosed generally relates to multipurpose pellets. More specifically, the subject matter disclosed generally relates to multipurpose pellets containing vegetable fiber and recycled cellulosic material.

(b) Related Prior Art

Fuel pellets of different compositions of materials have been used for heating since the mid-nineteen eighties. Typically, the fuel pellets are burned in a stoker stove, and are associated with residential style heating systems. Due to increased environmental awareness and a demand for new sources of energy, an alternative fuel source can be created by recycling waste products. Since 1984, when the first pellet-burning stove was introduced by Pyro Industries, there has been an increased interest in creating a pellet fuel comprised of waste paper, waste cardboard and agricultural residues.

Several fuel pellets comprised of cellulosic materials have been patented. For example, U.S. Pat. No. 4,236,897 to Johnston discloses a fuel pellet comprised of natural cellulosic material and synthetic polymeric thermoplastic material. Johnston further discloses using binding agents in the composition of the fuel pellet in addition to thermoplastic materials, such as paraffin slack wax and carnauba wax.

U.S. Pat. No. 5,342,418 to Jesse discloses a method of making a fuel pellet comprised of cellulosic material. The fuel pellet described therein is comprised of 60 to 90 percent by weight of cellulosic material, and 10 to 40 percent by weight of a thermoplastic resin. The fuel pellet disclosed by Jesse purposefully produces an ash output of at least 1 percent by weight, so as to protect the equipment which carries the fuel into the furnace.

While each of the above described fuel pellet compositions and methods of making the fuel pellets function adequately, they each have the drawback of requiring the addition of a binder material to bind the cellulosic particles together. Fuel pellets have been manufactured without the presence of binder material, but they require that the cellulosic particles be highly compressed together in order to increase the temperature of the particles and activate the natural lignin present therein, which will act as a natural binder material. Fuel pellets manufactured with a binder material can be manufactured at much lower pressures since it is not necessary to melt the lignin, as the binder material will bind the cellulosic particles together. Therefore, there is a need for a fuel pellet composition that does not require the addition of a binder material, and that can be manufactured at lower pressures.

Moreover, while the above described pellet composition and methods of making the pellets demonstrate adequate functions, there is a need in the art to improve stall bedding choices. Because of the shortcomings of straw, horse owners have been looking for better bedding materials. Actually, wood shavings are the most common bedding alternatives to straw. The main reason for the use of wood bedding is that the majority of horses in stables have allergies stemming from fungal spores and bacteria in straw bedding. On the other hand, because horses need extra cushion and dryness in there stalls, liquid absorbing pellet can have a higher absorbency than wood shavings to help promote healthy hooves and overall general health of the animal. Therefore, there is a need for a pellet composition that promotes a higher absorbency than wood shavings.

There is also a need for a liquid absorbing pellet to be used as a bedding material or a hydroseeding material.

There exist no pellets that can be used as a bedding material or as a mulch.

### SUMMARY

In a first embodiment there is disclosed a pellet comprising:

from about 0.1% to about 100% by weight of a vegetable fiber chosen from cotton, bamboo fiber, rice fiber, esparto, papaya, coir, sisal, kapok, jute, ramie, flax, roselle hemp, hemp, kenaf, abaca, soybean fiber, okra fiber, vine fiber, banana fiber, rattan and nettlesjute; and

from about 99.9% to about 0% by weight of cellulosic material.

The pellet may further comprise a cereal chosen from maize, rice, wheat, barley, sorghum, millets, oats, rye, tricale, buckwheat, finio, quinoa, and spelt.

The cellulosic material may chosen from:

cardboard, card stock, carton, corrugated fiberboard, paperboard, paper, and newspaper; and

a biomass chosen from wood, sawdust, wood shavings, bagasse, fruit pit, fruit core, vegetable pit, vegetable core, maize leaf, straw and grass and switchgrass.

The pellet may further comprise liquid absorbing synthetic material comprising fabric, meshes or films. The synthetic material is chosen from polyesters laminated or coated with polyvinyl chloride (PVC), and woven fiberglass coated with polytetrafluoroethylene (PTFE).

The pellet may further comprise lime, and the lime may be lime suitable for agriculture.

The pellet may further comprise an absorbent, and the absorbent may be magnesium chloride (MgCl₂). The magnesium chloride may be suitable for agriculture.

The pellet has an absorptive capacity ratio of 10:1 compared to wood shavings.

The cereal contained in the pellet may be chosen from a whole grain, a endocarp of a grain, a germ of a grain, a bran of a grain, a powder from a whole grain, a powder from a endocarp of a grain, a powder from a germ of a grain, and a powder from a bran of a grain.

In a second embodiment, there is disclosed an animal bedding comprising the pellet of the present invention.

The animal bedding may be further comprising pieces of vegetable fiber chosen from cotton, bamboo fiber, rice fiber, esparto, papaya, coir, sisal, kapok, jute, ramie, flax, roselle hemp, hemp, kenaf, abaca, soybean fiber, okra fiber, vine fiber, banana fiber, rattan and nettlesjute.

In a third embodiment, there is disclosed an agricultural mulch which may comprise the pellet according to the present invention. The agricultural mulch may further comprise a color pigment.

In a fourth embodiment, there is disclosed a method of manufacturing the pellet which comprises:

a) crushing and mixing the vegetable fiber and the cellulosic material;

b) measuring humidity content of the vegetable fiber and the cellulosic material of a), adjusting the humidity content of the materials of the pellet; and

c) forming the pellet.

The method may further comprise from about 1% to about 20% by weight of cereal.

The method may further comprise from about 20% to about 35% synthetic material.

The preferred humidity content for the manufacture of the pellet is from about 6% to about 17%.

When the humidity content is above about 17%, the method may further comprise addition of additional cellulosic material, and further mixing.

When the humidity content is below about 6%, the method may further comprise the addition of at least one of a liquid, such as water, and further mixing.

The method of manufacturing the pellet may also comprise the addition of lime.

The method of manufacturing the pellet may also comprise the addition of magnesium chloride.

The method of manufacturing the pellet may also comprise reserving the materials of the pellet after crushing and mixing.

The following terms are defined below.

The term “cellulosic material” is intended to mean material that contains lignocellulose, which is composed mainly of cellulose, hemicellulose and lignin. Lignocellulose is the structural material that comprises much of the mass of plants, which is used to make pulp for the fabrication of paper, cardboard and other products from wood.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

FIG. 1 is a block diagram of the process of making the pellet of the present invention.

### DETAILED DESCRIPTION OF THE PREFERRED EMBODIMENTS

This invention provides an improved pellet providing augmented absorptive capacity for use as a bedding with live animals or as a water support mixture in hydroseeding. The absorbing capacity ratio of the multipurpose pellets is 10 to 1 compared to wood shavings.

The pellet after having been first used as an animal bedding can be further used as a fertilizer. When the pellet is made of 100% natural fibers (vegetable fiber and/or cellulosic material), it is entirely biodegradable.

Hydroseeding is a planting process which utilizes a slurry of seed and mulch. Hydroseeding is an alternative to the traditional process of broadcasting or sowing dry seed. It promotes quick germination and inhibits soil erosion. The pellet of the present invention may replace the mulch in the hydroseed mixture, and help maintain the moisture level of the seed and seedlings. The slurry often has other ingredients including fertilizer, tackifying agents, green dye and other additives, or a used pellet of the present invention having been first used as an animal bedding.

When used as an animal bedding, the pellet of the present invention noticeably reduce or almost eliminate the odour or smell of urine or animal dropping that remains present with other animal bedding products. According to one embodiment of the present invention, the pellet of the present invention may be used as bedding material alone, in their granular form. According to another embodiment of the present invention, the pellet of the present invention may be used as bedding mixed with other shredded absorbing material, so as to provide a soft material on which animals may comfortably rest. For example, the other shredded absorbing material may be a mixture of the raw material for making the pellets of the present invention (as described below) that has not been pelleted. For example, the shredded material may be comprised of pieces of vegetable fiber chosen from cotton, bamboo fiber, rice fiber, esparto, papaya, coir, sisal, kapok, jute, ramie, flax, roselle hemp, hemp, kenaf, abaca, soybean fiber, okra fiber, vine fiber, banana fiber, rattan and nettlesjute.

According to another embodiment of the present invention, the pellet of the present invention may also be used as mulch or protective covering of rotting vegetable matter spread to reduce evaporation and soil erosion. The mulch may be preferably used in flowerbeds, to prevent growth of undesired weeds. The mulch may be colored with color pigment so as to provide a nice aesthetic appearance to the flowerbeds.

According to one embodiment of the present invention, the pellet may have pesticide effect. Without wishing to be bound by theory, the pellets of the present invention, as an animal bedding, may act as insecticide by reducing the number of insects such as flies in barns stalls. Furthermore, the pellet of the present invention, as an animal bedding, may act as larvicide by reducing or eliminating white grubs (e.g. Phyllophaga anxia, Amphimallon majalis, Popillia japonica) from the stalls. Furthermore, the pellet of the present invention, as a mulch, may act as insecticide by reducing or eliminating spiders (and their webs) from flowerbeds.

The pellet of the present invention may be formed in any shape desired. The pellet of the present invention may also be formed in any size desired.

An example of a pellet of the present invention is comprised of a plurality of layers and partial layers stacked one upon another, and extending in a direction generally transverse to the longitudinal axis of the pellet. The layers generally comprise components of the materials from which the pellets are made, and they are typically rather thin, and packed tightly together in the pellet. A transverse surface of the pellet (e.g. either ends, or a new surface made by breaking the pellet along a transverse direction) typically comprises a plurality of partial layers folded, mixed, and otherwise randomly entwined and entangled with each other in both the axial and transverse directions. The flexible nature of the cellulosic material used within the composition of the pellets may also result in some cellulosic material being packed and extend along the axial length of the pellet. However, the pellets do contain some layers which comprise a single layer element extending across the entire transverse dimensional area of the pellet. Furthermore, some materials used in the fabrication of the pellets will retain their granular character (e.g. grains) and will be incorporated within the layered stacks of the pellets and will extend across the length of several layers of the cellulosic material used in the pellet.

The pellet of the present invention is made from a selected composition of recycled waste as raw materials. Preferred raw materials are clean or soiled recycled non-waxed cellulosic materials which are obtained from post-consumer recuperation operations. The raw material suitable for use in this invention may be secured in the form of sheets, films, bulk fiber, or the like, or is readily converted to one or more of those forms.

The composition of raw material suitable for use herein generally comprises a first and second components.

The first vegetable fiber component chosen from cotton, bamboo fiber, rice fiber, esparto, papaya, coir, sisal, kapok, jute, ramie, flax, roselle hemp, hemp, kenaf, abaca, soybean fiber, okra fiber, vine fiber, banana fiber, rattan and nettlesjute, is present from about 0.1% to about 100% by weight, and preferably about 20 to 95% by weight, based on dry weight.

The second cellulosic material component which may be comprised of a dense cellulosic fiber stock such as cardboard, card stock, carton, corrugated fiberboard, paperboard, paper, news paper and other heavy duty, as well as other conventional paper used in writing, printing or packaging activities.

The cellulosic material may also be a biomass such as sawdust, wood shavings, and grass, such as any of the panicum species of grasses (e.g. panicum amarun, panicum anceps, panicum antidotale, panicum decompositum (native millet), panicum miliare (little millet), panicum virgatum (switchgrass) or panicum grus-galli) and the like. Residues from harvest such as maize leaf, and straw, residues from agricultural extraction processes such as bagasse, fruit or vegetable pits and cores may also be sources of biomass.

According to one embodiment of the present invention, the pellet of the present invention may also comprise lime. Preferably, the lime used in the pellet of the present invention may be lime used for agricultural purposes and which contains calcium oxide and may contain magnesium oxide. The addition of lime allows the destruction of pathogenic micro-organism which may be present in the raw material used for making the present invention, by rapidly increasing the pH.

According to one embodiment of the present invention, the pellet of the present invention may also comprise an absorbent to maximize the absorption properties of the present invention. Any suitable absorbent may be used in accordance with the present invention. Preferably, the absorbent may be magnesium chloride (MgCl₂). Liquid or powdered magnesium chloride (MgCl₂) helps to control dust and erosion. It is hygroscopic, and makes it absorb moisture from the air, controlling the number of small particles which become airborne. Owners of indoor arenas (e.g. for horse riding) may apply magnesium chloride to sand or other floor materials to control dust. Preferably, the magnesium chloride used for the present invention may be suitable for agricultural uses.

The pellet of the present invention does not require the addition of any thermoplastic resins. The material used herein allow the use of lower pressures during the fabrication of the pellets, since it is not necessary to use high pressures to melt the natural lignin present in cellulosic materials to bind them together. They are preferred for their lubrication properties and their ability to soften and flow at low temperatures to assist in the bonding together of the pellets during pellet fabrication.

Pellets having the above compositions present absorptive capacity ratio 10:1 than conventional wood shavings bedding.

Method of Making the Pellets

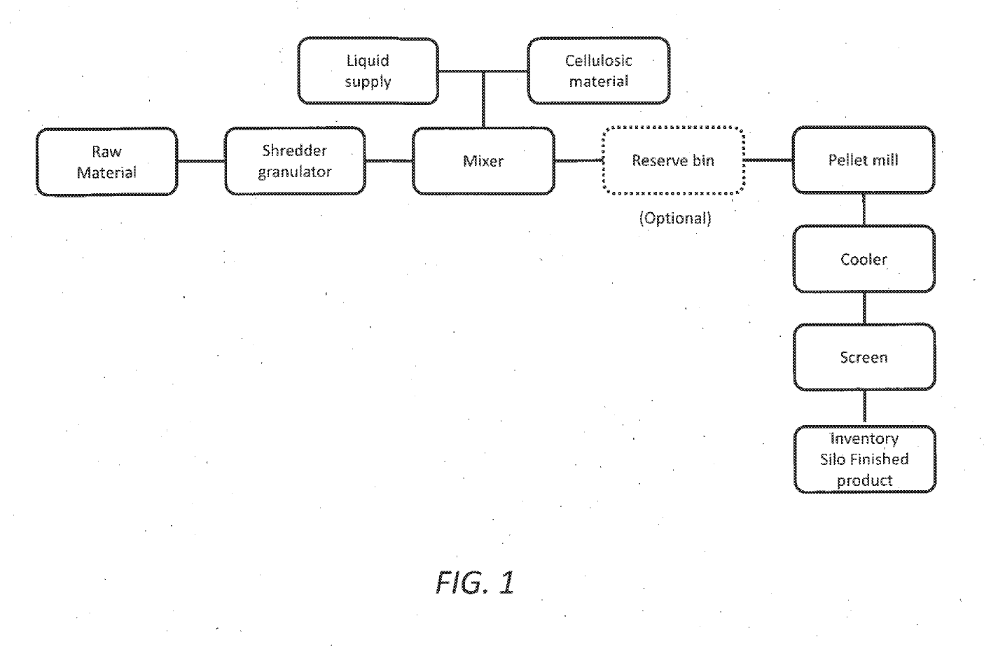

Now referring to FIG. 1, for manufacture of the pellets of the present invention, the raw materials, as described and defined above, are preferably fed into a shredder (crusher, or granulator), which does the initial size reduction, and from there into a hammer mill or other size reducing apparatus (e.g. a pulveriser), where the raw material is further reduced to the desired size. The preferred size of the particle is about 0.25 inches. The hammer mill or pulveriser has a size controlling exit screen which controls the size of the exiting milled material. The details of the shredder and pulveriser (or hammer mill) structure and operation are not shown as these are well known in the pelletizing art.

Next, the shredded materials are mixed to uniformly distribute the humidity within the mixture. The humidity content is tested to be about 6% to about 17%, and preferably 15.5%. Moisture content of the mixture of materials is important to produce pellets of a high quality, to prevent the mixture of the materials of the composition to be too pasty and, importantly, to prevent burning of the materials inside the pelleting apparatus because of the high heat generated during the pelletizing step. To adjust a humidity content that is too low, a suitable quantity of liquid containing material or liquid, preferably water is added to the composition. Dry cellulosic material is added to the composition to adjust the humidity content if it is too high. Optionally, the mixed materials may then be transferred to a reserve bed before they are introduced into the pelletizing apparatus.

The mixed materials from the hammer mill/pulveriser are fed to a pelletizing apparatus. The pelletizing apparatus is generally conventional in design. The details of the pelletizing apparatus structure and operation are not shown as these are well known in the pelletizing art. The pelletizing apparatus may optionally have a conditioning unit, but its use during the pelletizing step of the pellet of the present invention is not necessary.

As the formed pellets are extruded from the pelletizing apparatus, they tend to break off due to weight of the extrudate, the vibration of the mill, or they are cut by a knife adapted to cut them at a predetermined length, or the like, and fall down onto a conveyor or a receiving bin. The pellets are transported to a screen over which the pellets are passed to remove fines. The pelletized product which does not pass through the screen is then transported, for example, by conveyor to the finished product container.

### ALTERNATIVE EMBODIMENTS

### Example I

### Animal Bedding

An exemplary pellet composition for use as an animal bedding is prepared by mixing the following components:

| Vegetable fiber | Cellulosic material | Cereal |
|---|---|---|
| Jute fiber (20%) | Sawdust (79%) | Wheat (1%) |

The materials were crushed, shredded and mixed, the humidity content was adjusted to about 8%, and pellets were prepared in a pelletizing apparatus.

The bedding pellet has an absorbing capacity ratio of 10 to 1 compared to wood shavings.

### Example II

### Hydroseeding

An exemplary pellet composition for use as a hydroseeding is prepared by mixing the following components:

| Vegetable fiber | Cellulosic material | Cereal |
|---|---|---|
| Bamboo fiber (30%) | Cardboard (68%) | Corn (2%) |

The materials were crushed, shredded and mixed, the humidity content was adjusted to 8%, and pellets were prepared in a pelletizing apparatus.

The hydroseeding pellet has an absorbing capacity ratio of 10 to 1 compared to usual mulch.

### Example III

### Fuel Pellet

An exemplary pellet composition for use as a fuel pellet is prepared by mixing the following components:

| Vegetable fiber | Cellulosic material | Cereal |
|---|---|---|
| jute fiber (40%) | Cardboard (57%) | Buckwheat (3%) |

The materials were crushed, shredded and mixed, the humidity content was adjusted to 8%, and pellets were prepared in a pelletizing apparatus.

The fuel pellets has about 7800 Btu/pound.

### Example IV

### Use as Bedding for Horse Stall

A pellet composition according to example 1 is placed on the floor of a barn with 10 stalls for horses, replacing a wood shaving bedding normally used for bedding purposes. Male or females horses of all ages are kept in the stalls. After placement of the pellet composition of the present invention, the stalls are evaluated for the amount of pellet composition necessary for performing the same as the wood shaving bedding normally used. The stalls are inspected for cleanliness, dryness, and the odor associated with horse urine is also evaluated.

Approximately four to five bags of wood shaving bedding are normally used in the 10 stalls, on a daily basis. Replacement of the wood shaving bedding with the pellet composition of the present invention required only two bags of identical weight (a reduction of about 50 to 60%). The stalls are found to be noticeably cleaner and dryer, as all traces of horse urine have been absorbed by the pellets of the present invention, in contrast to the wood shaving bedding that would only partially absorb the horse urine and leave wet puddles.

The dryness of the stall visibly improved the dryness of the animal's hooves and appears to improve the health and texture of the hooves and feet, and the animal's comfort.

Interestingly, the urine odor in the stall as well as in the entire barn was noticeably lower, or almost absent after replacement of the wood shaving bedding with the pellet composition of the present invention.

The animals are found to be not eating the pellet composition of the present invention. The lesser amount of pellets of the present invention used reduced the amount of waste produced. Thus, the savings caused by the use of the pellet of the present invention are twofold: less pellets used to obtain a similar absorption performance, and less waste product produced.

### Example IV

### Use as Bedding for Domestic Animal Cages

A pellet composition according to example 1 is placed on the flooring of a animals cages in a pet shop. The pellet composition of the present invention is replacing a granular bedding material normally used for bedding purposes in domestic animals. The animals cages comprised rats, mice, hamsters, rabbits, birds as well as kittens. The amount of the pellet composition of the present invention is employed in the cages is identical to the amount of the previously used bedding material.

After placement of the pellet composition of the present invention, the cages are evaluated for cleanliness, dryness, and the odor associated with animal droppings is also evaluated.

After a 3 day period, the cages containing the rodents (rats, mice, hamsters, rabbits) appears dry and clean, a net improvements over the previous bedding material which needs to be changed every day as the cages are unclean and wet. The pellet composition of the present invention displays superior absorption capacity over the previous bedding material. Moreover, the pellet composition of the present invention are a more secure product for use with rodents: the previous bedding material contains a significant amount of dust, while the pellet composition of the present invention is noticeably less dusty and thus safer for the small animals.

Interestingly, the smell associated with animal dropping, as well as in the entire pet shop was noticeably lower, or almost absent after replacement of the previous bedding material with the pellet composition of the present invention. The pellet composition of the present invention appears to be non toxic to most animals, as no animals died of ingesting it during the trial period.

### Example IV

### Use as Mulch in Flowerbeds

A pellet composition according to example 1 is placed on a flowerbed comprising plants, next to two adjacent flowerbeds, one covered with cedar mulch, and the second covered with wood shaving bedding. All three flowerbeds are tended and watered, and the growth of weeds is observed at one month after covering and two months after covering. After one month, both the cedar mulch and wood shaving bedding comprised a few weeds growing therein, while the flowerbed covered with the pellet composition of the present invention remained clear of weeds. After two month, both the cedar mulch and wood shaving bedding comprised weeds growing therein, while the flowerbed covered with the pellet composition of the present invention still remained clear of weeds.

The embodiments and examples presented herein are illustrative of the general nature of the subject matter claimed and are not limiting. It will be understood by those skilled in the art how these embodiments can be readily modified and/or adapted for various applications and in various ways without departing from the spirit and scope of the subject matter disclosed claimed. The claims hereof are to be understood to include without limitation all alternative embodiments and equivalents of the subject matter hereof. Phrases, words and terms employed herein are illustrative and are not limiting. Where permissible by law, all references cited herein are incorporated by reference in their entirety. It will be appreciated that any aspects of the different embodiments disclosed herein may be combined in a range of possible alternative embodiments, and alternative combinations of features, all of which varied combinations of features are to be understood to form a part of the subject matter claimed.

1. A pellet comprising:
from about 0.1% to about 100% by weight of a vegetable fiber chosen from cotton, bamboo fiber, rice fiber, esparto, papaya, coir, sisal, kapok, jute, ramie, flax, roselle hemp, hemp, kenaf, abaca, soybean fiber, okra fiber, vine fiber, banana fiber, rattan and nettlesjute; and
from about 99.9% to about 0% by weight of cellulosic material.

2. The pellet of claim 1, which further comprises a cereal chosen from maize, rice, wheat, barley, sorghum, millets, oats, rye, tricale, buckwheat, finio, quinoa, and spelt.

3. The pellet of claim 1, wherein the cellulosic material is chosen from cardboard, card stock, carton, corrugated fiberboard, paperboard, paper, and newspaper.

4. The pellet of claim 1, wherein the cellulosic material is a biomass chosen from wood, sawdust, wood shavings, bagasse, fruit pit, fruit core, vegetable pit, vegetable core, maize leaf, straw and grass and switchgrass.

5. The pellet of claim 1, further comprises liquid absorbing synthetic material comprising fabric, meshes or films.

6. The pellet of claim 5, wherein the synthetic material is chosen from polyesters laminated or coated with polyvinyl chloride (PVC), and woven fiberglass coated with polytetrafluoroethylene (PTFE).

7. The pellet of claim 1, further comprising lime.

8. The pellet of claim 1, further comprising an absorbent.

9. The pellet of claim 8, wherein said absorbent is magnesium chloride (MgCl₂).

10. The pellet of claim 7, wherein said lime is suitable for agriculture.

11. The pellet of claim 9, wherein said magnesium chloride is suitable for agriculture.

12. An animal bedding comprising the pellet of claim 1.

13. The animal bedding according to claim 12, further comprising pieces of vegetable fiber chosen from cotton, bamboo fiber, rice fiber, esparto, papaya, coir, sisal, kapok, jute, ramie, flax, roselle hemp, hemp, kenaf, abaca, soybean fiber, okra fiber, vine fiber, banana fiber, rattan and nettlesjute.

14. An agricultural mulch comprising the pellet of claim 1.

15. The agricultural mulch of claim 14, further comprising a color pigment.

16. A method of manufacturing a pellet of claim 1 comprising:
a) crushing and mixing the vegetable fiber and the cellulosic material;
b) measuring humidity content of the vegetable fiber and the cellulosic material of a), adjusting the humidity content of the materials of the pellet.

17. The method of claim 16, further comprising a step c) after step b):
c) forming the pellet.

18. The method of claim 16, further comprising from about 1% to about 20% by weight of cereal.

19. The method of claim 16, further comprising from about 20% to about 35% synthetic material.

20. The method of claim 16, wherein the humidity content is from about 6% to about 17%.

21. The method of claim 16, wherein when the humidity content is above about 17%, the method further comprises addition of cellulosic material, and further mixing.

22. The method of claim 16, wherein when the humidity content is below about 6%, the method further comprises an addition of at least one of a liquid, and further mixing.

23. The method of claim 22, wherein said liquid is water.

24. The method of claim 16, further comprising the addition of lime.

25. The method of claim 16, further comprising the addition of magnesium chloride.

26. The method of claim 16, further comprising reserving materials of the pellet after crushing and mixing before step c).
